(19) United States
(12) Patent Application Publication
(10) Pub. No.: US 2015/0049078 A1
(43) Pub. Date: Feb. 19, 2015

(54) MULTIPLE PERSPECTIVE INTERACTIVE IMAGE PROJECTION

(71) Applicant: MEP TECH, INC., Salt Lake City, UT (US)

(72) Inventors: Donald Roy Mealing, Park City, UT (US); Mark L. Davis, Salt Lake City, UT (US); Roger H. Hoole, Salt Lake City, UT (US); Matthew L. Stoker, Bountiful, UT (US); W. Lorenzo Swank, Bountiful, UT (US); Michael J. Bradshaw, Bountiful, UT (US)

(21) Appl. No.: 13/968,232

(22) Filed: Aug. 15, 2013

(51) Int. Cl. G06F 3/03; G06T 19/20; G06T 5/00

(52) U.S. Cl. CPC G06F 3/0304; G06T 5/006; G06T 19/20
USPC 345/419; 345/619; 345/647; 345/625; 345/156

(57) ABSTRACT

The projection of interactive images such that different images are pre-edited so that when projected, the image is better suited for viewing from a particular perspective. Thus, a variety of images might be projected such that some are suitable for one perspective, some are suitable for another perspective, and so forth. For instance, one image might be edited so that when projected, the projected first image is presented for better viewing from a first perspective. Another image might be edited so that when projected, the projected second image is presented for better viewing from a second perspective.

### BACKGROUND

There are a variety of conventional displays that offer an interactive experience supported by a computing system. Computer displays, for example, display images, which often have visualizations of controls embedded within the image. The user may provide user input by interacting with these controls using a keyboard, mouse, controller, or another input device. The computing system receives that input, and in some cases affects the state of the computing system, and further in some cases, affects what is displayed.

In some cases, the computer display itself acts as an input device using touch or proximity sensing on the display. Such will be referred to herein as “touch” displays. There are even now touch displays that can receive user input from multiple touches simultaneously. When the user touches the display, that event is fed to the computing system, which processes the event, and makes any appropriate change in computing system state and potentially the displayed state. Such displays have become popular as they give the user intuitive control over the computing system at literally the touch of the finger.

For instance, touch displays are often mechanically incorporated into mobile devices such as tablet device or smartphone, which essentially operate as a miniature computing system. That way, the footprint dedicated for input on the mobile device may be smaller, and even perhaps absent altogether, while still allowing the user to provide input. As such, mobile devices are preferably small and the display area is often also quite small.

### BRIEF SUMMARY

Embodiments described herein relate to the ability to interact with different projected images that are pre-edited so that when projected, the image is better suited for viewing from a particular perspective. Thus, a variety of images might be projected such that some are suitable for one perspective, some are suitable for another perspective, and so forth. For instance, one image might be edited so that when projected, the projected first image is presented for better viewing from a first perspective. Another image might be edited so that when projected, the projected second image is presented for better viewing from a second perspective.

This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 abstractly illustrates a system in accordance with the principles described herein, which includes a controller, a projection system, and a camera system;

FIG. 2 illustrates a flowchart of a method for presenting interactive images in a manner as to be suitable for viewing from particular perspectives;

FIG. 3 illustrates a computing system that may be used to implement aspects described herein;

FIG. 4 illustrates a system that is similar to that of FIG. 1, except that a shuttering system is used to provide different perspectives;

FIG. 5 abstractly illustrates a system that includes an image generation device that interfaces with an accessory that projects an interactive image sourced from the image generation device;

FIG. 6 abstractly illustrates an image generation device accessory, which represents an example of the accessory of FIG. 5;

FIG. 7 illustrates a flowchart of a method for an image generation device accessory facilitating interaction with a projected image along the path involved with projecting the image;

FIG. 8 illustrates a flowchart of a method for processing the input image to form a derived image;

FIG. 9 illustrates a flowchart of a method for an image generation device accessory facilitating interaction with a projected image along the path involved with passing input event information back to the image generation device;

FIG. 10 illustrates a perspective view of several example accessories that represent examples of the accessory of FIG. 5;

FIG. 11 illustrates a back perspective view of the assemblies of FIG. 10 with appropriate image generation devices docked, or wirelessly connected therein;

FIG. 12 illustrates a front perspective view of the assemblies of FIG. 10 with appropriate image generation devices docked therein; and

FIG. 13 illustrates a second physical embodiment in which the projection system is a projector mounted to a ceiling; and

FIG. 14A illustrates a side view of a third physical embodiment in which the projection system is incorporated into a cam light system; and

FIG. 14B illustrates a bottom view of the cam light system of FIG. 14A.

### DETAILED DESCRIPTION

The principles described herein relate to the projection of interactive images such that different images are pre-edited so that when projected, the image is better suited for viewing from a particular perspective. Thus, a variety of images might be projected such that some are suitable for one perspective, some are suitable for another perspective, and so forth. For instance, one image might be edited so that when projected, the projected first image is presented for better viewing from a first perspective. Another image might be edited so that when projected, the projected second image is presented for better viewing from a second perspective.

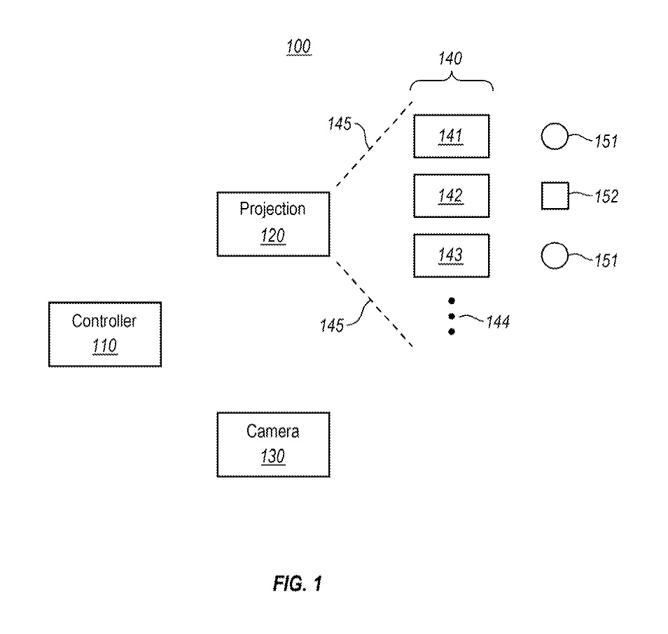

FIG. 1 abstractly illustrates a system 100 in accordance with the principles described herein. The system 100 includes a controller 110, a projection system 120 and a camera system 130. The projection system 120 is illustrated as having projected images 140, which include projected image 141, projected image 142, and projected image 143. However, the ellipses 144 represent that the projection system 120 may be used to project other images as well. The camera system 130 detects user interactions within the field of projection 145. Each of the images might be a static image, or it might be a dynamic image. For instance, a dynamic image might be a constantly refreshed image that has multiple frames, and that may be capable of representing continuous motion to the human mind.

The projected images 140 are each projected on the same surface, which is positioned within the field of projection 145 of the projection system 120. Although the images 140 are illustrated as different images, some or all of the images 140 might be based on the same image, but with different pre-editing to allow for better viewing from respective different perspectives. Some or all of the projected images 140 might be projected at the same time, and some or all of the projected images 140 might be projected one after the other. Although the projected images 140 are illustrated one over the other in FIG. 1, the projected images 140 may even be projected on the same portion of the surface.

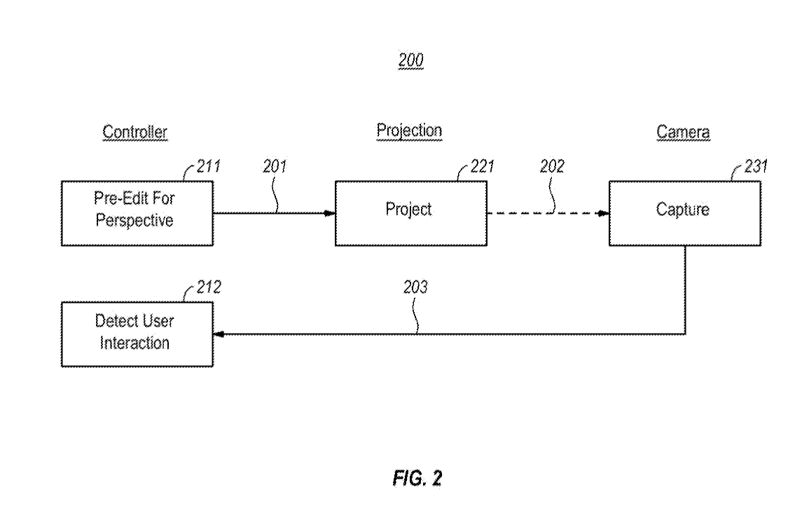

FIG. 2 illustrates a flowchart of a method 200 for presenting interactive images in a manner as to be suitable for viewing from particular perspectives. Perspectives 151 and 152 are abstractly represented in FIG. 1, but more concrete examples of perspectives will be described further below.

The system 100 may perform the method 200 so as to make each of the projected images more suitable for one perspective than for other perspectives. For instance, the system 100 causes the image 141 to be more suitable for viewing from perspective 151 (abstractly represented as a circle) than from perspective 152 (abstractly represented as a square). The system 100 causes the image 142 to be more suitable for viewing from perspective 152 than from perspective 151. Also, the system causes the image 143 to be more suitable for viewing from perspective 151 than from perspective 152. Thus, one or more of the images projected by the projection system 130 have a first perspective as the best perspective (“best” meaning out of the possible perspectives that the projection system 130 may aim for optimizing), one or more of the projected images may have a second perspective as the best perspective, and so on, for possible other numbers of perspectives.

Referring to FIG. 2, some acts of the method 200 (acts 211 and 212) are performed by the controller 110 as represented in the left column of FIG. 1 under the header “Controller”. One of the acts of the method 200 (act 221) is performed by the projection system 120 as represented in the middle column of FIG. 2 under the header “Projection”. One of the acts of the method 300 (act 231) is performed by the camera system 130 as represented in the right column of FIG. 2 under the header “Camera”.

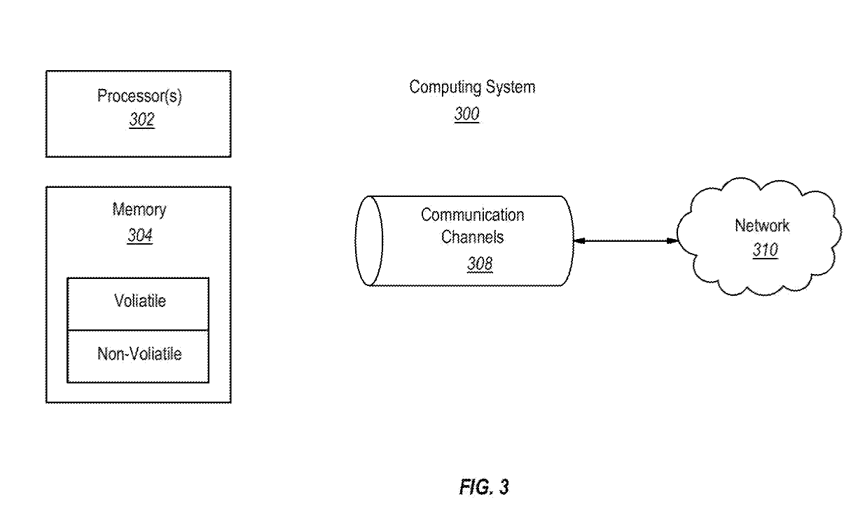

The controller 110 may perform its functions by using hardware, firmware, software, or a combination thereof. In one embodiment, in which the controller 110 uses software, the controller 110 may be a computing system. Accordingly, a basic structure of a computing system will now be described with respect to the computing system 300 of FIG. 3.

As illustrated in FIG. 3, in its most basic configuration, a computing system 300 typically includes at least one processing unit 302 and memory 304. The memory 304 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “executable module” or “executable component” can refer to software objects, routings, or methods that may be executed on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory 304 of the computing system 300. Computing system 300 may also contain communication channels 308 that allow the computing system 300 to communicate with other message processors over, for example, network 310.

Embodiments described herein may comprise or utilize a special purpose or general-purpose computer including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other tangible medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

The method 200 of FIG. 2 will now be described in further detail. The controller 110 edits an image that is to be projected (act 211) so that when projected by the projection system, the projected image is presented for better viewing from a particular perspective (act 211) as compared to other enabled perspectives. The pre-editing may also take into consideration any known user preferences of a user who is viewing the image from that particular perspective. The edited image is then provided to the projection system (as represented by arrow 201), whereupon the projection system projects the image onto a surface (act 221). At some point, the user interacts (as represented by the dashed-line arrow 202) within the field of projection of the projected image, causing the camera system to capture data representing the user interaction (act 231). The controller then obtains (as represented by arrow 203) and uses this captured data to detect a user input event (act 212).

For instance, in the context of FIG. 1, the controller 110 pre-edits an image (act 211) in a manner that the image is designed to be better viewed from perspective 151 as compared to perspective 152, whereupon the projection system 120 projects (act 221) the corresponding image 141, the camera system 130 detects (act 231) user interaction data, and the controller 110 detects the user input event (act 212). For image 142, the controller 110 pre-edits the image (act 211) in a manner that the image is designed to be better viewed from perspective 152 as compared to perspective 151, whereupon the projection system 120 projects (act 221) the corresponding image 142, the camera system 130 detects (act 231) user interaction data, and the controller 110 detects the user input event (act 212). Finally, for image 143, the controller 110 pre-edits an image (act 211) in a manner that the image is designed to be better viewed from perspective 151 as compared to perspective 152, whereupon the projection system 120 projects (act 221) the corresponding image 143, the camera system 130 detects (act 231) user interaction data, and the controller 110 detects the user input event (act 212).

Several examples of pre-editing for specific perspectives will now be described. The nature of the perspectives that the controller 110 pre-edits images for may depend on the projection system 100 and its deployment.

Keystoning

For instance, in an embodiment described further below, the image is projected onto a surface that is not perpendicular to the direction of projection. An example of this might be if the system 100 is an accessory to an image generation device, such as a smart phone, which assessor actually sits on the same surface as the surface onto which the accessory is projecting. In this case, keystoning, may occur. For instance, the width of the projected image will increase the further away the surface is from the projection source, thus resulting in a trapezoid-like shape, or a keystone-line shape.

Suppose now that there are three users that sit around a table, which is the surface onto which the projection is occurring. The keystoning will be observed differently for each of those sitting around the table. Accordingly, the pre-editing of the image may reduce the effects of keystoning when taking into consideration which of the three users is prioritized for viewing the particular image. For instance, if this were a game, in which the three were taking turns in the game, the image might be optimized for the user whose turn it presently is within the game. Thus, for one user who is viewing the projected surface from one angle, the image may be edited in a manner in which keystoning is reduced when viewed from that angle. For another user who is viewing the projected surface from another angle, the image may be edited in a manner in which keystoning is reduced when viewing from that angle, and so forth.

Object Adornment

Another example of pre-editing may be performed in response to the detection of an object within a field of projection of the projected image. For instance, suppose that a human hand of a user is inserted into the field of projection of the image. Upon detecting this, the image may be pre-edited such that the portion of the image corresponding to a location of the detected object is modified.

As an example, the image could be modified so as to colorize the object that has been placed into the field of projection. For instance, a hand coming in from one side of the projection might be colorized blue, a hand coming in from another side of the projection might be colorized red, and a hand coming in from yet another side of the projection might be colorized green. This may be accomplished by editing that portion of the image which emits upon the object such that the portion is of the color that the object is to be colorized. Of course, the object is not limited to a human hand, but might include other objects as well, such as a game piece.

As a further example, rather than only colorize the object inserted into the field of projection, one or more controls may be emitted onto the object inserted into the projection. Such may be accomplished by pre-editing the image to include one or more controls corresponding to the portion of the image that emits on the inserted object. The user might interact with the controls on the inserted object to thereby cause data representing a user input event to be captured by the camera system. For instance, in the case of a human hand, if the user were to insert their hand into the field of projection with the hand open and palm facing down, the image might be pre-edited so that each finger is adorned with a projected control. The control might be activated by, for example, bending that finger.

Transparency Emulation

The object inserted into the field of view may also be made to appear transparent to a particular user from a particular point of view by using pre-editing of the image. This might be accomplished by modifying the image during pre-editing such that the detected object has displayed thereon image data that is obscured by the detected object from the particular perspective. For instance, suppose that a game board is being displayed, and that a user inserts his hand into the field of projection. The image might then be pre-edited so that those portions of the projected game board that the user cannot see due to the presence of the hand, are instead projected on the hand itself. If done well enough, it will appear to the user that the user's hand goes in and out of existence when inserted into the field of projection.

In other embodiments, perhaps most of the object is emulated transparent in this way, but there might be instances in which it is desirable to have one or more portions of the object not be transparent. For instance, suppose the user preferences indicate that the user uses her index finger to do touch events on the surface on which the image is projected. In that case, perhaps all of the hand is emulated as transparent, except for the last inch of the index finger of the user. This allows the user to see what they are selecting, and understand where their selecting finger is, while still allowing the projection to appear to emit through the remainder of the hand.

Multiple Projectors

In some embodiments, there might be multiple projectors in the projections system 120, each projecting from a different angle and having a different field of projection, but still projecting the same image so that the fields of projection converge on the surface. In this case, if an object is detected in either or both of the fields of projection, then the copy of the image to be projected for one or both of the projectors might be blanked out in the area corresponding to the inserted object so as to not provide non-convergent versions of the image on the detected object. Of course, as described above, one of the copies of the image might be edited to perform colorization or adornment of the detected object also. The projectors may be positioned so as to reduce shadowing caused by objects inserted into the field of projection. For instance, a shadow created by the object in a first field of projection may be covered by a second field of projection of the image.

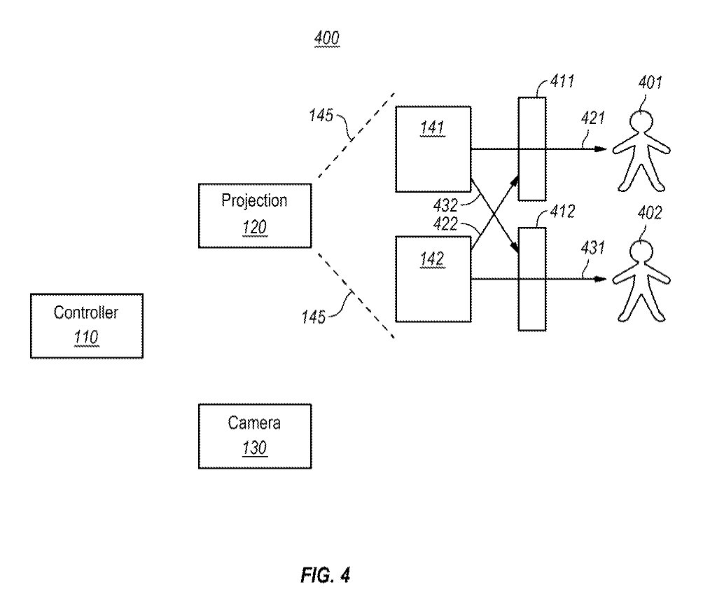

FIG. 4 illustrates a system 400 that is similar to that of FIG. 1 in that it also includes the controller 110, the projection system 120 and the camera system 130. The projection system 120 is illustrated as projecting the two images 141 and 142. In this case, the perspective is that the users view the image through a shuttering system. For instance, a first user 401 views the first image 141 through the first shuttering system 411 as represented by arrow 421, but cannot view the second image 142 through the first shuttering system 411 as represented by arrow 422. Likewise, the second user 402 views the second image 142 through the second shuttering system 412 as represented by arrow 431, but cannot view the first image 141 through the second shuttering system 412 as represented by arrow 432. This is possible if the frames of the first and second images 141 and 142 are interleaved, and the shuttering system is synchronized with the interleaving.

Each of the projected images might also be a three-dimensional image such that a portion of the frames of the corresponding image are to be viewed by a left eye of the corresponding user through the corresponding shuttering system, and such that a portion of the frames of the corresponding image are to be viewed by a right eye of the corresponding user through the corresponding shuttering system. For instance, the following Table 1 represents how the frames could be projected, and how the shuttering system would work to present three (3) three-dimensional images to corresponding three (3) users in which each three-dimensional frame is refreshed every 1/60 seconds.

TABLE 1

| | | Projection/Shuttering State | | | | | |
|---|---|---|---|---|---|---|---|
| Time (Seconds) | | User 1 | | User 2 | | User 3 | |
| From | To | Left | Right | Left | Right | Left | Right |
| 0 | 1/360 | Yes | | | | | |
| 1/360 | 2/360 | | | Yes | | | |
| 2/360 | 3/360 | | | | | Yes | |
| 3/360 | 4/360 | | Yes | | | | |
| 4/360 | 5/360 | | | | Yes | | |
| 5/360 | 1/60 | | | | | | Yes |
| 1/60 | 7/360 | YES | | | | | |
| 7/360 | 8/360 | | | YES | | | |
| 8/360 | 9/360 | | | | | YES | |
| 9/360 | 10/360 | | YES | | | | |
| 10/360 | 11/360 | | | | YES | | |
| 11/360 | 2/60 | | | | | | YES |

In Table 1, the first six rows represent the projection and viewing by the respective user of the first frame of each of the three-dimensional images. The last six rows represent the projection and viewing by the respective user of the second frame of each of the three-dimensional images. A “Yes” for the first frame (and a “YES” for the second frame) represents that during this time frame, the particular image for the particular eye of the respective user is being projected, and thus the particular shutter for that particular eye of the respective user is open. The shutter of the other eye for that respective user, and all shutters for all of the other users are closed (as represented by the corresponding column being blank for that time frame). In this manner, three individuals can see entirely different three-dimensional images being projected on a surface. Of course, this principle might extend to any number of users and any number of projected images. Furthermore, some of the images might be two-dimensional for one or more of the users, and some of the images might be three-dimensional for one or more of the users. Whether or not something presents in two-dimensions or three dimensions might be a user preference.

The shuttering system described above allows different users to see different images entirely. The shuttering system also allows the same image to be viewed by all, but perhaps with a customized “fog of war” placed upon each image suitable for the appropriate state. For instance, one image might involve removing image data from one portion of the image (e.g., a portion of a game terrain that the user has not yet explored), while one image might involve removing image data from another portion of the image (e.g., a portion of the same game terrain that the other user has not yet explored).

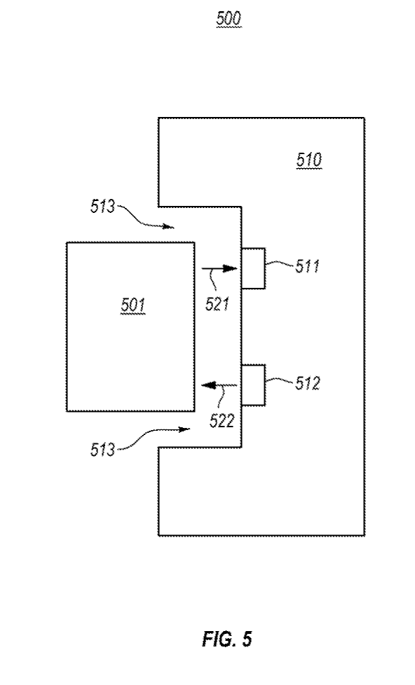

Accordingly, the principles described herein allow for complex interactive projection of one or more images onto a surface. In one embodiment, the system 100 is an accessory to another image generation device. FIG. 5 abstractly illustrates a system 500 that includes an image generation device 501 that interfaces with an image generation device accessory 510 (also simply referred to hereinafter as an “accessory”). The image generation device 501 may be any device that is capable of generating an image and which is responsive to user input. As examples only, the image generation device 501 may be a smartphone, a tablet device, a laptop. In some embodiments, the image generation device 501 is a mobile device although not required.

FIG. 5 is an abstract representation in order to emphasize that the principles described herein are not limited to any particular form factor for the image generation device 501 or the accessory 510. The accessory 510 is an example of the system 100 of FIG. 1. Likewise, the system 500 as a whole is an example of the system 100 of FIG. 1. A more concrete physical example of this first embodiment will be described further below, but FIG. 5 is also abstract for now.

A communication interface is provided between the image generation device 501 and the accessory 510. For instance, the accessory 510 includes input communication interface 511 that receives communications (as represented by arrow 521) from the image generation device 501, and an output communication interface 512 that provides communications (as represented by arrow 522) to the image generation device 501. The communication interfaces 511 and 512 may be wholly or partially implemented through a bi-directional communication interface though not required. Examples of communication interfaces include wireless interfaces, such as provided by 802.xx wireless protocols, or by close proximity wireless interface such as BLUETOOTH®. Examples of wired communication interface include USB and HDMI. However, the principles described herein are not limited to these interfaces, nor are they limited to whether or not such interfaces now exist, or whether they are developed in the future.

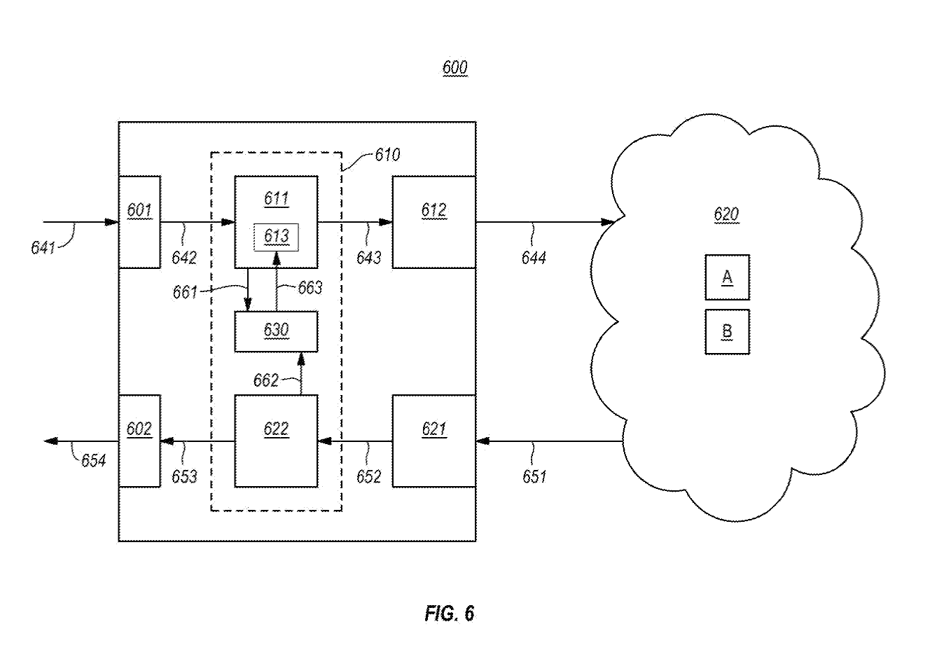

FIG. 6 abstractly illustrates an image generation device accessory 600, which represents an example of the accessory 510 of FIG. 5. For instance, the accessory 600 includes an input interface 601 for receiving (as represented by arrow 641) an input image from an image generation device (not shown in FIG. 6) when the image generation device is interacting with the accessory. For instance, if the accessory 600 were the accessory 510 of FIG. 5, the input interface 601 would be the input interface 511 of FIG. 5. In that case, the accessory 600 would receive an input image from the image generation device 501 over the input interface 601.

An image generation device accessory 600 also includes a processing module 610 that includes a post-processing module 611 that receives the input image as represented by arrow 642. The processing module 610 is an example of the controller 110 of FIG. 1. The post-processing module 611 performs processing of the input image to form a derived (or “post-processed”) image, which it then provides (as represented by arrow 643) to a projector system 612. Examples of processing that may be performed by the post-processing module 611 includes the insertion of one or more control visualizations into the image, the performance of distortion correction on the input image, or perhaps the performance of color compensation of the input image to form the derived image. Another example includes blacking out, colorizing, or adorning, a portion of the projection such that there is no projection on input devices or objects (such as a human hand or arm) placed within the scope of the projection.

The projector system 612 projects (as represented by arrow 644) at least the derived image of the input image onto a surface 620. The projector system 612 is an example of the projection system 120 of FIG. 1. In this description and in the claims, projecting “at least the derived image” means that either 1) the input image itself is projected in the case of there being no post-processing module 611 or in the case of the post-processing module not performing any processing on the input image, or 2) a processed version of the input image is projected in the case of the post-processing module 611 performing processing of the input image.

In the case of projecting on the same surface on which the accessory sits, there might be some post-processing of the input image to compensate for expected distortions, such as keystoning, when projecting at an acute angle onto a surface. Furthermore, although not required, the projector might include some lensing to avoid blurring at the top and bottom portions of the projected image. Alternatively, a laser projector might be used to avoid such blurring when projecting on a non-perpendicular surface.

Returning to FIG. 6, the projected image 620 includes control visualizations A and B, although the principles described herein are not limited to instances in which controls are visualized in the image itself. For instance, gestures may be recognized as representing a control instruction, without there being a corresponding visualized control.

The control visualizations may perhaps both be generated within the original input image. Alternatively, one or both of the control visualizations may perhaps be generated by the post-processing module 611 (hereinafter called “inserted control visualization”). For instance, the inserted control visualizations might include a keyboard, or perhaps controls for the projection system 612. The inserted control visualizations might also be mapped to control visualizations provided in the original input image such that activation of the inserted control visualization results in a corresponding activation of the original control visualization within the original image.

The accessory 600 also includes a camera system 621 for capturing data (as represented by arrow 551) representing user interaction with the projected image. The camera system 621 is an example of the camera system 130 of FIG. 1. A detection mechanism 622 receives the captured data (as represented by arrow 652) detects an image input event using the captured data from the camera system 621. If the control visualization that the user interfaced with was an inserted control visualization that has no corresponding control visualization in the input image, then the processing module 610 determines how to process the interaction. For instance, if the control was for the projector itself, appropriate control signals may be sent to the projection system 612 to control the project in the manner designated by the user interaction. Alternatively, if the control was for the accessory 600, the processing system 610 may adjust settings of the accessory 600.

If the control visualization that the user interfaced with was one of the control visualizations in the original input image, or does not correspond to a control that the processing system 610 itself handles, the detection mechanism 622 sends (as represented by arrow 653) the input event to the output communication interface 602 for communication (as represented by arrow 654) to the image generation device.

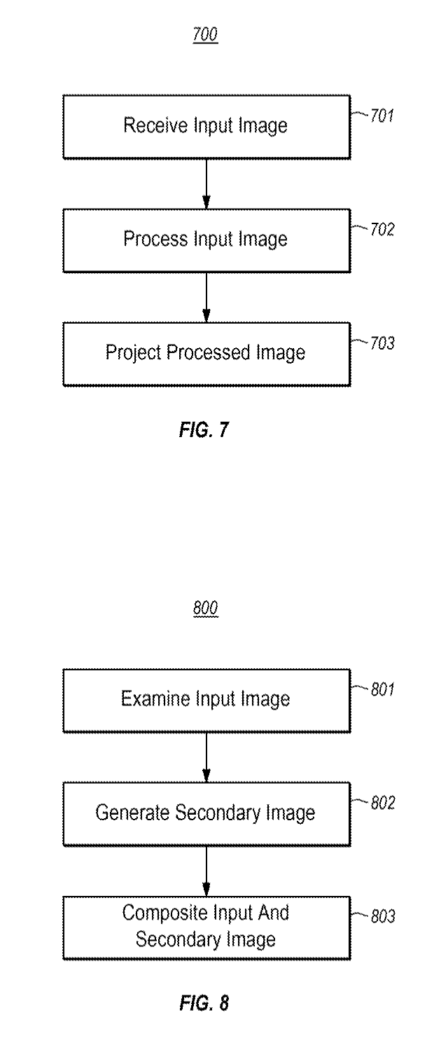

FIG. 7 illustrates a flowchart of a method 700 for an image generation device accessory facilitating interaction with a projected image. As an example only, the method 700 may be performed by the accessory 600 of FIG. 6. Accordingly, the method 700 will now be described with frequent reference to FIG. 6. In particular, the method 700 is performed as the input image and derived image flow along the path represented by arrows 641 through 644.

In particular, the accessory receives an input image from the image generation device (act 701). This is represented by arrow 641 leading into input communication interface 601 in FIG. 6. The input image is then optionally processed to form a derived image (act 702). This act is part of the pre-editing described above with respect to act 211 of FIG. 2. This is represented by the post-processing module 611 receiving the input image (as represented by arrow 642), whereupon the post-processing module 611 processes the input image. The at least derived image is then projected onto a surface (act 703). For instance, the projection system 612 receives the input image or the derived image as represented by arrow 642, and projects the image as represented by the arrow 644.

FIG. 8 illustrates a flowchart of a method 800 for processing the input image to form the derived image. As such, the method 800 represents an example of how act 702 of FIG. 7 might be performed. Upon examining the input image (act 801), a secondary image is generated (act 802). The secondary image is then composited with the input image to form the derived image (act 803).

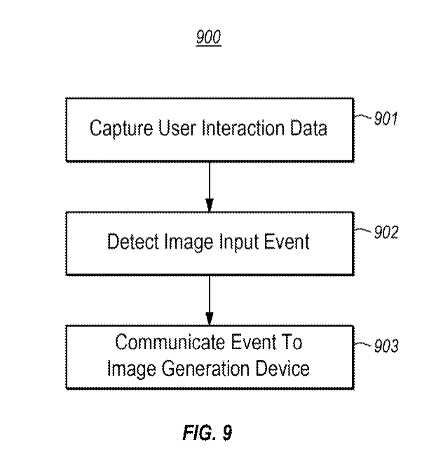

FIG. 9 illustrates a flowchart of a method 900 for an image generation device accessory facilitating interaction with a projected image. As an example only, the method 900 may be performed by the accessory 600 of FIG. 6. Accordingly, the method 900 will now be described with frequent reference to FIG. 6. In particular, the method 900 is performed as information flows along the path represented by arrows 651 through 654.

The camera system captures data representing user interface with the projected image (act 901). For instance, the camera system might capture such data periodically, such as perhaps at 60 Hz or 120 Hz. Several examples of such a camera system will now be described. A first camera system will be referred to as a “light plane” camera system. A second camera system will be referred to as a “structured light” camera system. Each of these camera systems not only capture light, but also emit light so that resulting reflected light may be captured by one or more cameras. In these examples, the light emitted from the camera system is not in the visible spectrum, although that is not a strict requirement. For instance, the emitted light may be infra-red light.

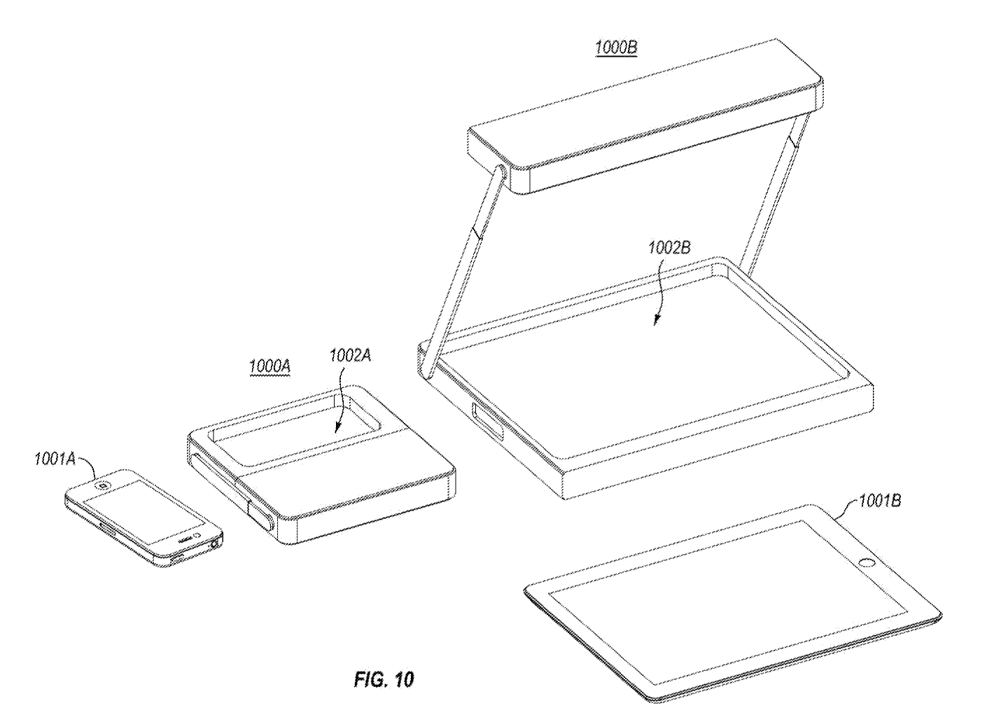

The light plane camera system is particular useful in an embodiment in which the accessory sits on the same surface on which the image is projected. The camera system of the accessory might emit an infrared light plane approximately parallel to (and in close proximity to) the surface on which the accessory rests. More regarding an example light plane camera system will be described below with respect to FIGS. 10 through 12.

The infra-red image fed by the camera system 621 to the detection module 622. In the structured light camera system example, that image includes the reflected structured light that facilitates capture of depth information. The detection module 622 may detect the depth information, and be able to distinguish objects placed within the field of camera view. It may thus recognize the three-dimensional form of a hand and fingers placed within the field of view.

This information may be used for any number of purposes. One purpose is to help the post-processing unit 611 black out those areas of the input image that corresponds to the objected placed in the field of view. For instance, when a user places a hand or arm into the projected image, the projected image will very soon be blacked out in the portions that project on the hand or arm. The response will be relatively fast such that it seems to the user like he/she is casting a shadow within the projection whereas in reality, the projector simply is not emitting in that area. The user then has the further benefit of not being distracted by images emitting onto his hands and arm.

Another user of this depth information is to allow complex input to be provided to the system. For instance, in three-dimensional space, the hand might provide three positional degrees of freedom, and 3 rotational degrees of freedom, providing potentially up to 6 orthogonal controls per hand. Multiple hands might enter into the camera detection area, thereby allowing a single user to use both hands to obtain even more degrees of freedom in inputting information. Multiple users may provide input into the camera detection area at any given time.

The detection module 622 may further detect gestures corresponding to movement of the object within the field of camera view. Such gestures might involve defined movement of the arm, hands, and fingers of even multiple users. As an example, the detection module 622 might have the ability to recognize sign language as an alternative input mechanism to the system.

Another use of the depth information might be to further improve the reliability of touch sensing in the case in which both the structured light camera system and the light plane camera system are in use. For instance, suppose the depth information from the structured light camera system suggests that there is a human hand in the field of view, but that this human hand is not close to contacting the projection surface. Now suppose a touch event is detected via the light plane camera system. The detection system might invalidate the touch event as incidental contact. For instance, perhaps the sleeve, or side of the hand, incidentally contacted the projected surface in a manner not to suggest intentional contact. The detection system could avoid that turning into an actual change in state. The confidence level associated with a particular same event for each camera system may be fed into a Kalman filtering module to arrive at an overall confidence level associated with the particular event.

Other types of camera systems include depth camera and 3-D camera. The captured data representing user interaction with the projected image may then be provided (as represented by arrow) to a detection system 623 which applies semantic meaning to the raw data provided by the camera system. Specifically, the detection system 623 detects an image input event using the captured data from the camera system (act 902). For instance, the detection system 623 might detect a touch event corresponding to particular coordinates. As an example only, this touch event may be expressed using the Human Interface Device (HID) protocol.

In the light plane camera system example, the detection system 623 might receive the infra-red image captured by the infra-red camera and determine where the point of maximum infrared light is. From this information, and with the detection system 623 understanding the position and orientation of each infra-red camera, the detection system 623 can apply trigonometric mathematics to determine what portion of the image was contacted.

In making this calculation, the detection system 623 might perform some auto-calibration by projecting a calibration image, and asking the user to tap on certain points. This auto-calibration information may be used also to apply some calibration adjustment into the calculation of which portion of the projected image the user intends to contact.

The detection system 623 might also apply auto-calibration after the initial calibration process, when the user is actually interacting with a projected image. For instance, if the system notices that the user seems to select a certain position, and then almost always later correct by selecting another position slightly offset in a consistent way, the system might infer that this consistent offset represent an unintended offset within the initial selection. Thus, the detection system might auto-calibrate so as to reduce the unintended offset.

Returning to FIG. 9, the accessory then communicates the detected input event to the image generation device (act 903). For instance, the output interface 802 may have established a transmit socket connection to the image generation device. The image generation device itself has a corresponding receive socket connection. If the operating system itself is not capable of producing such a receive socket connection, an application may construct the socket connection, and pass it to the operating system.

The input event may take the form of floating point value representations of the detecting contact coordinates, as well as a time stamp when the contact was detected. The image generation device receives this input event via the receive socket level connection. If the receive socket level connection is managed by the operating system, then the event may be fed directly into the portion of the operating system that handles touch events, which will treat the externally generated touch event in the same manner as would a touch event directly to the touch display of the image generation device. If the receive socket level connection is managed by the application, the application may pass the input event into that same portion of the operating system that handles touch events.

As previously mentioned, the post-processing module 611 may perform color compensation of the input image prior to projecting the image. As the accessory may be placed on all types of surfaces including non-white surfaces, non-uniformly colored surfaces, and the like, the characteristics of the surface will impact the colorization of the viewed image. The color compensation component 630 accounts for this by comparing the color as viewed to the color as intended, and performing appropriate adjustments. This adjustment may be performed continuously. Thus, the system may respond dynamically to any changes in the surface characteristics. For instance, if the accessory is moved slightly during play, the nature of the surface may be altered.

The principles described herein are not limited to any particular physical deployment. However, three example physical deployments will now be described in further detail In the first described physical deployment, the controller, the projection system, and the camera system are all integrated, and are designed to sit on a same flat surface as the surface on which the projection system projects. In the second described embodiment, the projector system is mounted to a ceiling. In the third described physical deployment, the projection system is suitable for connection within a ceiling to emit a projection downward onto a horizontal surface (such as a floor, table, or countertop).

First Physical Embodiment

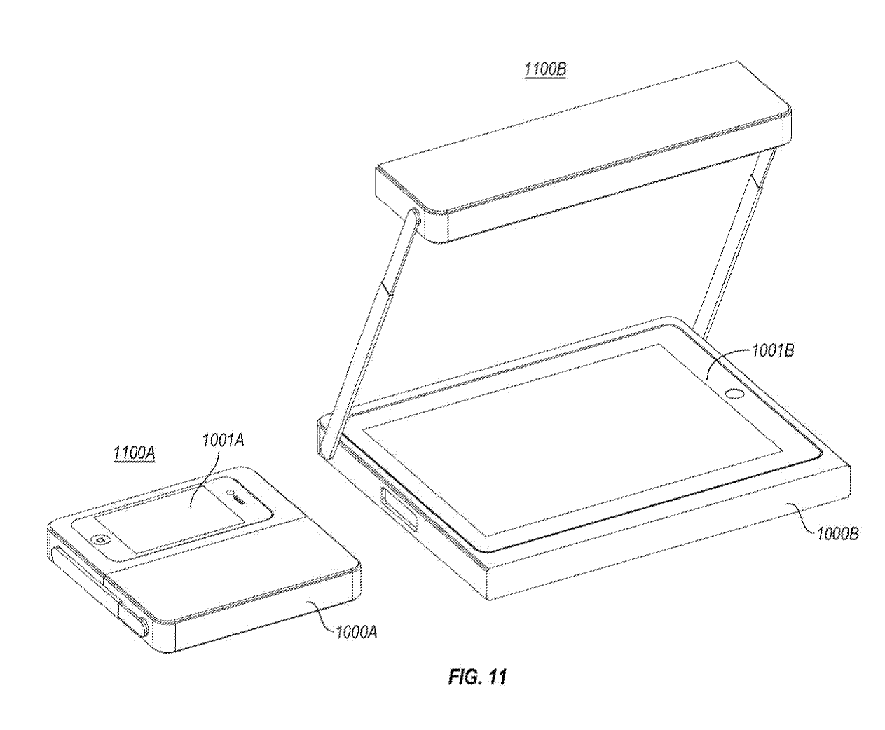

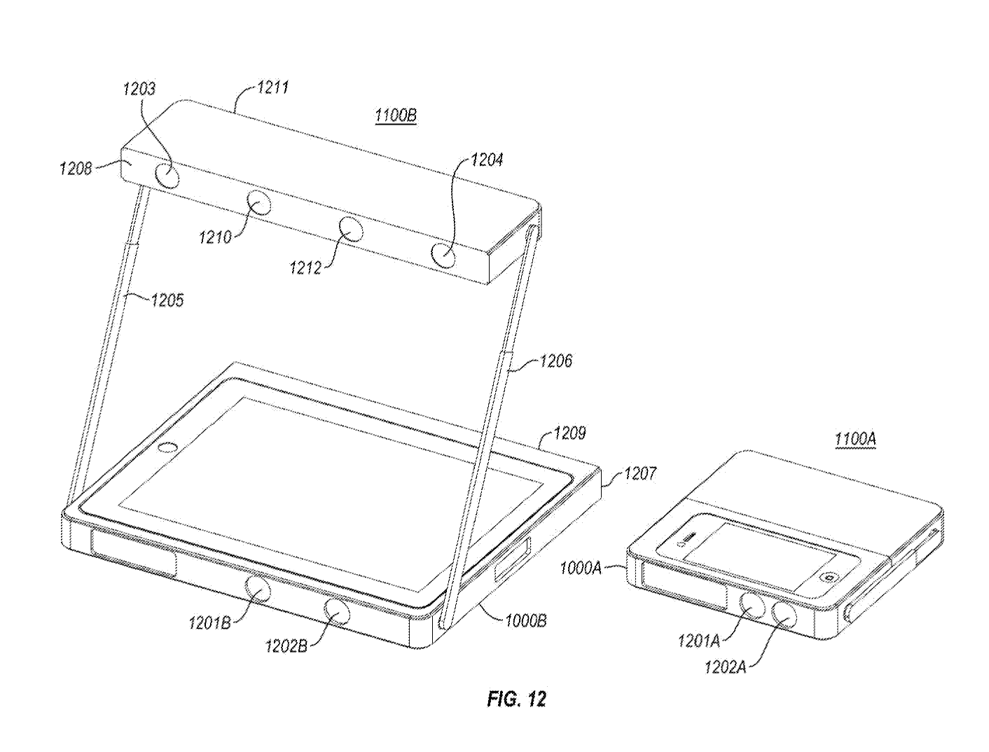

FIG. 10 illustrates a perspective view of an accessory 1000A that represents an example of the accessory 610 of FIG. 6, and which includes a port 1002A into which an image generation device 1001A may be positioned. In this case, the image generation device 1001A is a smartphone. FIG. 11 illustrates a back perspective view of the assembly 1100A, which is the combination of the image generation device 1001A installed within the port 1002A of the accessory 1000A. FIG. 12 illustrates a front perspective view of the assembly 1100A.

FIG. 10 also illustrates a perspective view of an accessory 1000B that represents an example of the accessory 610 of FIG. 6, and which includes a port 1002B into which an image generation device 1001B may be positioned. In this case, the image generation device 1001B is a tablet device. FIG. 11 illustrates a back perspective view of the assembly 100B, which is the combination of the image generation device 1001B installed within the port 1002B of the accessory 1000B. FIG. 12 illustrates a front perspective view of the assembly 1100B. In FIG. 10, though the image generation device 1001A and 1001B are illustrated as being distinct components as compared to the respective accessories 1000A and 1000B. However, this need not be the case. The functionality described with respect to the image generation device and the associated projection accessory may be integrated into a single device.

The light plane camera system (described above) is particular useful in an embodiment in which the accessory sits on the same surface on which the image is projected. The camera system of the accessory might emit an infrared light plane approximately parallel to (and in close proximity to) the surface on which the accessory rests. For instance, referring to FIG. 12, the accessory 1000A includes two ports 1201A and 1202A, which each might emit an infrared plane. Likewise, the accessory 1000B includes two portions 1201B and 1202B, each emitting an infrared plane. Each plane might be generated from a single infrared laser which passes through a diffraction gradient to produce a cone-shaped plane that is approximately parallel to the surface on which the accessory 1000A or 1000B sits. Assuming that surface is relatively flat, the infrared planes will also be in close proximity to the surface on which the image is projected. Infra-red light is outside of the visible spectrum, and thus the user will not typically observe the emissions from ports 1201A and 1202A of accessory 1000A, or the emissions from ports 1201B and 1202B of accessory 1000B.

An infrared camera system may be mounted in an elevated portion of the accessory to capture reflections of the infra-red light when the user inserts an object into the plane of the infra-red light. For instance, referring to FIG. 12, there may be two infra-red cameras 1203 and 1204 mounted in elevated portion 1211. The use of two infra-red emitters 1201B and 1202B and two infra-red cameras 1203 and 1204 is a protection in case there is some blockage of one the emissions and/or corresponding reflections.

Referring to FIG. 12, the accessory 1000B is illustrated in extended position that is suitable for projection. There may also be a contracted position suitable for transport of the accessory 1000B. For instance, arms 1205 and 1206 might pivot about the base portion 1207 and the elevated portion 1211, allowing the elevated portion 1211 to have its flat surface 1208 abut the flat bottom surface 1209 of the base portion 1207. For instance, accessory 1000A is shown in its contracted position, but accessory 1000A might also be positioned in an extended position with an elevated portion that includes all of the features of the elevated portion 1211 of the accessory 1200B. The arms 1205 and 1206 might be telescoping to allow the elevated portion 1211 to be further raised. This might be particularly helpful in the case of accessory 1000A, which has smaller dimensions than the accessory 1000B.

In the example of the light plane camera system, when an object is positioned to touch the surface in the area of the projected image, the object will also break the infra-red plane. One or both of the infra-red cameras 1203 or 1204 will then detect a bright infra-red light reflecting from the object at the position in which the object breaks the infra-red plane. As an example, the object might be a pen, a stylus, a finger, a marker, or any other object.

In the structured light camera system, infra-red light is again emitted. In the example of FIG. 12, infra-red light is emitted from the emitter 1212. However, the infra-red light is structured such that relative depth information can be inferred from the reflections of that structured infra-red light. For instance, in FIG. 4, the structured light reflections may be received by infra-red cameras 1203 and 1204.

The structured light might, for example, be some predetermined pattern (such as a repeating grid pattern) that essentially allows for discrete sampling of depth information along the full extent of the combined scope of the infra-red emitter 1212 and the infra-red cameras 1203 and 1204. As an example only, the infra-red emitter 1212 might emit an array of dots. The infra-red cameras 1203 and 1204 will receive reflections of those dots, wherein the width of the dot at each sample point correlates to depth information at each sample point. A visible range camera 1210 captures the projected images.

Second Physical Embodiment

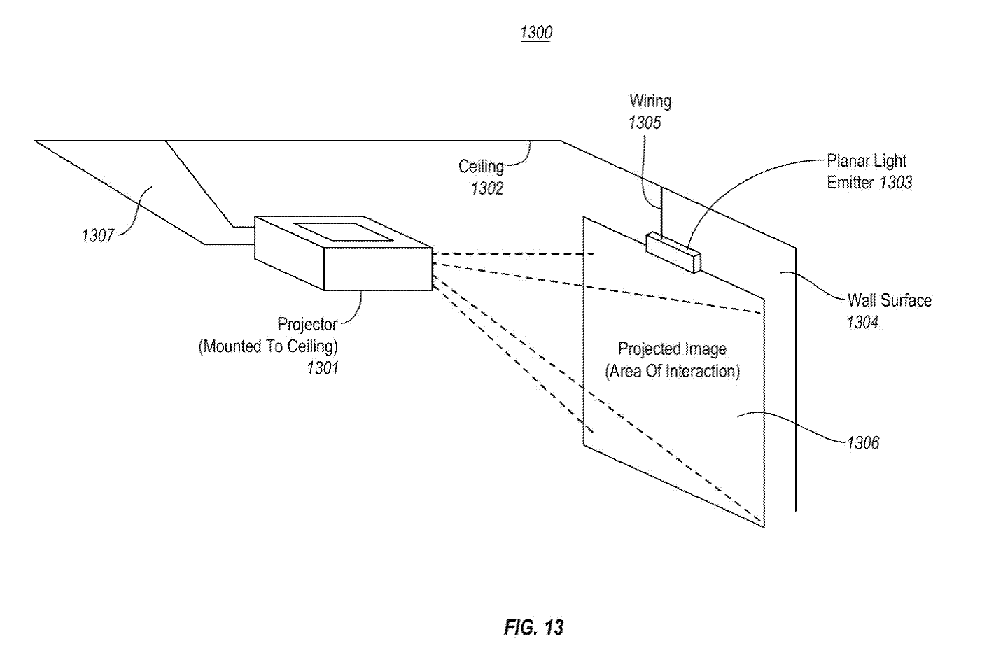

FIG. 13 illustrates a second physical embodiment 1300 in which the projection system 120 is a projector 1301 mounted to a ceiling 1302 using mechanical mounts 1307. Here, the projector projects an image 1306 onto a vertical wall surface 1304. A planar light emitter 1303 (which represents an example of the camera system 130) emits co-planar infra-red light planes, and based on reflections, provides capture depth information to the projector 1301. For instance, the planar light emitter 1303 send electrical signals over wiring 1305, although wireless embodiments are also possible. The controller 110 may be incorporated within the projection system 1301.

Third Physical Embodiment

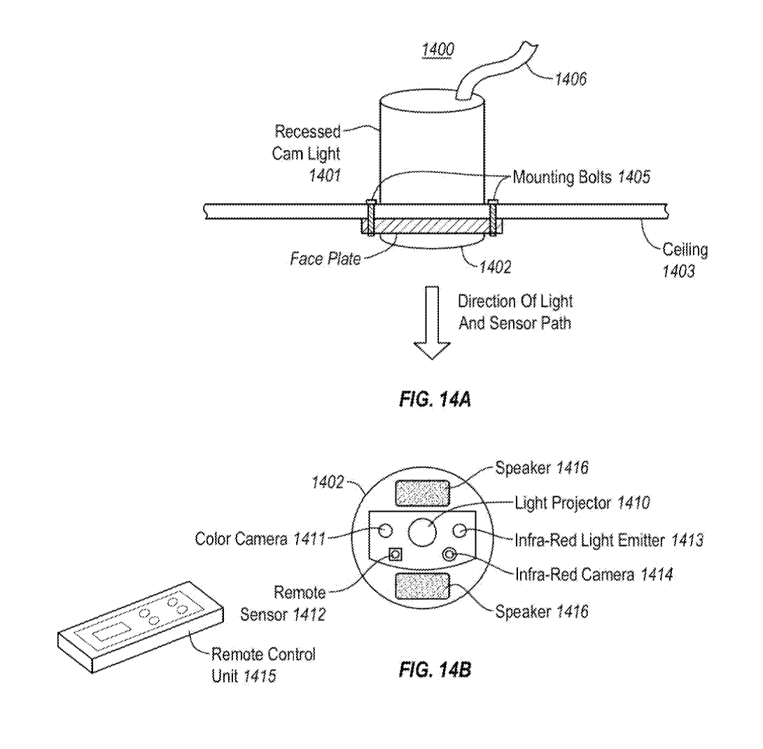

FIGS. 14A and 14B illustrates a third physical embodiment 1400 in which the projection system is incorporated into a cam light. FIG. 14A illustrates a side view of the cam light system 1400. The cam light system 1400 includes the cam light 1401 in which embodiments of the controller 110, the projection system 120, and the camera system 130 are integrated. The cam light 1401 includes an exposed portion 1402 that faces downward into the interior of the room whilst the remainder is generally hidden from view above the ceiling 1403. A mounting plate 1404 and mounting bolts 1405 assist in mounting the cam light 1401 within the ceiling 1403. A power source 1406 supplies power to the cam light 1401.

FIG. 14B illustrates a bottom view, looking up, of the exposed portion 1402 of the cam light 1401. A visible light projector 1410 emits light downward onto a horizontal surface below the cam light 1400 (such as a table or countertop). When not projecting images, the visible light projector 1410 may simply emit visible light to irradiate that portion of the room, and function as a regular cam light. However, the remote controller 1415 may be used to communicate to the remote sensor 1412, when the light projector 1410 is to take on its image projection role. When projecting images, the color camera 1411 captures visible images reflected from field of projection. An infrared light emitter 1413 emits non-visible light so that the infrared camera 1414 may capture reflections of that non-visible light to thereby extract depth information and thus user interaction within the field of projection. Speakers 1416 emit sound associated with the projected visible image. Accordingly, users can quickly transition from sitting at the dinner table having a well-illuminated dinner, to a fun family game activity, without moving to a different location.

Accordingly, the principles described herein describe embodiments in which a dynamic interactive image may be projected on a surface by an accessory to the device that actually generates the image, thereby allowing interaction with the projected image, and thereby causing interactivity with the image generation device. As an example, the accessory may be an accessory to a smartphone or tablet, or any other image generation device.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product comprising one or more computer-readable storage media having thereon computer-executable instructions that are structured such that, when executed by one or more processors of a computing system, cause the computing system to perform a method comprising:
an act of editing a first image so that when projected, the projected first image is presented for better viewing from a first perspective;
an act of editing a second image so that when projected, the projected second image is presented for better viewing from a second perspective;
an act of detecting a first image input event using first captured data representing user interaction with the projected first image; and
an act of detecting a second image input event using second captured data representing user interaction with the projected second image.

2. The computer program product in accordance with claim 1,
the act of editing the first image occurring in a manner in which keystoning is reduced when viewed from a first angle; and
the act of editing the second image occurring in a manner in which keystoning is reduced when viewed from a second angle different than the first angle.

3. The computer program product in accordance with claim 1,
the act of editing the first image occurring in a manner in which keystoning is reduced when viewed from a first angle and when the projected first image is projected onto a surface that is not perpendicular to the direction of projection; and
the act of editing the second image occurring in a manner in which keystoning is reduced when viewed from a second angle different than the first angle and when the projected first image is projected onto the surface that is not perpendicular to the direction of projection.

4. The computer program product in accordance with claim 1, wherein the first and second image are the same image prior to the acts of editing.

5. The computer program product in accordance with claim 4,
the act of editing the first image comprising removing image data from a first portion of the first image; and
the act of editing the second image comprising removing image data from a second portion of the second image.

6. The computer program product in accordance with claim 1, the first image and the second image are each dynamic images having a plurality of frames, wherein the frames of the first image are interleaved with the frames of the second image, such that the first perspective is through a first shuttering system that permits the frames of the first image to be viewed but not the frames of the second image, and such that the second perspective is through a second shuttering system that permits the frames of the second image to be viewed but not the frames of the first image.

7. The computer program product in accordance with claim 6, wherein the first image is a three-dimensional image such that a portion of the frames of the first image are to be viewed by a left eye of a user through the first shuttering system, and such that a portion of the frames of the first image are to be viewed by a right eye of the user through the first shuttering system.

8. The computer program product in accordance with claim 7, wherein the second image is also a three-dimensional image such that a portion of the frames of the second image are to be viewed by a left eye of a second user through the second shuttering system, and such that a portion of the frames of the second image are to be viewed by a right eye of the second user through the second shuttering system.

9. The computer program product in accordance with claim 1, the method further comprising:
an act of detecting an object in a field of projection of the projected first image;
in response to the act of detecting the object in the field of projection, the act of editing the first image includes an act of editing the first image such that a portion of the first image corresponding to a location of the detected object is modified.

10. The computer program product in accordance with claim 9, wherein the portion of the first image is modified such that the detected object has a certain color.

11. The computer program product in accordance with claim 9, wherein the portion of the first image is modified such that the detected object has at a least one control displayed thereon, the user interaction with the projected first image comprising the user interacting with the control projected on the detected object.

12. The computer program product in accordance with claim 11, wherein the detected object is a hand, wherein the portion of the first image is modified such that the hand has a plurality of controls displayed thereon, each control corresponding to a predetermined portion of the hand.

13. The computer program product in accordance with claim 9, wherein the portion of the first image is modified such that the detected object has displayed thereon image data that is obscured by the detected object.

14. The computer program product in accordance with claim 9, wherein the editing of the first image is performed so as to incorporate one or more user preferences of a user that is to view the projected image from the first perspective.

15. A method comprising:
an act of a computing system editing a first image so that when projected, the projected first image is presented for better viewing from a first perspective as compared to a second perspective;
an act of a projection system projecting the first image onto a surface;
an act of a camera system capturing first captured data representing user interaction with the projected first image;
an act of the computing system detecting a first image input event using the first captured data representing user interaction;
an act of the computing system editing a second image so that when projected, the projected second image is presented for better viewing from the second perspective as compared to the first perspective; and
an act of the projection system projecting the second image onto the surface.

16. The method in accordance with claim 15, further comprising:
an act of the camera system capturing second captured data representing user interaction with the projected second image; and
an act of the computing system detecting a second image input event using the second captured data representing user interaction.

17. The method in accordance with claim 15, the act of the projection system projecting the first image onto the surface comprising:
an act of using a first projector to project the first image onto the surface from a first angle and having a first field of projection; and
an act of using a second projector to project the first image onto the surface from a second angle and having a second field of projection, such that the first and second fields of projection converge on the surface; and
an act of detecting an object in either or both of the first and second fields of projection of the projected first image;
in response to the act of detecting the object, the act of editing the first image includes an act of editing the first image for at least one of the fields of projection so as not to provide non-convergent versions of the first image onto the detected object.

18. A system comprising:
a projection system;
a camera system; and
a control system, wherein the control system is configured to perform the following method:
an act of editing a first image so that when projected by the projection system on a surface, the projected first image is presented for better viewing from a first perspective;
an act of editing a second image so that when projected by the projection system on the surface, the projected second image is presented for better viewing from a second perspective;
an act of detecting a first image input event using first captured data representing user interaction with the projected first image, the first captured data captured by the camera system; and
an act of detecting a second image input event using second captured data representing user interaction with the projected second image, the second captured data captured by the camera system.

19. The system in accordance with claim 18, wherein the projection system, the camera system, and the control system are integrated and are designed to sit on a same flat surface onto which the projection system projects.

20. The system in accordance with claim 19, wherein the projection system is configured to be attached to a ceiling.
